(19) United States
(12) Patent Application Publication
(10) Pub. No.: US 2005/0073420 A1
(43) Pub. Date: Apr. 7, 2005

(54) Child containment, communication and locating system

(76) Inventors: Ronald S. Kazdin, Newbury, OH (US); Thomas J. Radu, Chagrin Falls, OH (US)

Correspondence Address: James A. Hudak, Esq., Suite # 304, 29425 Chagrin Blvd., Cleveland, OH, 44122-4602, US

(21) Appl. No.: 10/676,452

(22) Filed: Oct. 2, 2003

(51) Int. Cl. G08B 23/00

(52) U.S. Cl. 340/573.4

(57) ABSTRACT

A system for containing a child within a defined area, for communicating with the child, and for locating the child if the child leaves the defined area is disclosed. The containment capability of the system is provided by a presently existing electronic pet containment system. The child wears a monitoring module that produces a signal that is transmitted back to a control unit in the possession of the parent, thus warning the parent if the child approaches or crosses the wire defining the boundary of the defined area. The parent can use the control unit transceiver to communicate with the child and the child can communicate with the parent using the transceiver within the monitoring module. If the child leaves the defined area, the control unit has locating capabilities that provide the parent with an indication as to the direction in which the child is moving and the distance between the child and the control unit.

### TECHNICAL FIELD

The present invention relates, in general, to a child containment, communication and locating system and, more particularly, to such a system wherein the child containment capability is provided by a presently existing pet containment system.

### BACKGROUND ART

Numerous systems relating to containing, communicating with and locating children are presently available. Such systems, however, typically do not include all of the aforementioned capabilities. For example, U.S. Pat. No. 4,136,338 (Antenore) discloses a perimeter alarm apparatus including a loop of wire that is placed within the ground so as to define the area in which the child is to be contained and electrical circuitry connected to the loop to detect the absence of a signal imposed on the loop. A sending unit is worn by the child and produces a signal that is imposed on the loop. If the child is within the defined area, the sending unit induces a signal on the loop. When the child moves beyond the loop by a pre-determined distance, no signal is imposed on the loop and an alarm is sounded. In the aforementioned patent, the signal is imposed on the loop by a sending unit worn by the child, rather than by a radio frequency transmitter under the control of the child's parent. In addition, means for communicating with the child or for determining the location of the child if the child leaves the defined area is not provided under the aforementioned patent.

U.S. Pat. No. 5,661,460 (Sallen, et. al.) discloses a distance determination and alarm system comprised of a plurality of transceiver units, one transceiver unit being in the possession of the parent and the other transceiver unit being worn by the child. The system produces an alarm when the transceiver unit worn by the child is more than a predetermined distance away from the transceiver unit in the possession of the parent. The distance is determined by the difference in the phase of a reference signal that is transmitted on a radio frequency signal by the parent's transceiver unit, then received and retransmitted by the child's transceiver unit, and then received again by the parent's transceiver unit. This patent does not include any means for containing the child within a pre-determined area and/or means for communicating with the child or locating the child.

U.S. Pat. No. 5,289,163 (Perez, et. al.) discloses a child locating device consisting of two transceiver units. The child's transceiver unit generates a signal that is received by the parent's transceiver unit. If the signal generated by the child's transceiver unit becomes weak as the result of the child exceeding a pre-determined distance from the parent's transceiver unit, an alarm is sounded by the parent's transceiver unit to alert the parent that the child has wandered away. The parent's transceiver unit also has a direction indicator function to assist in locating the child. This patent, however, makes no provision for containing the child within a pre-determined area.

U.S. Pat. No. 5,812,056 (Law) discloses a wireless child monitoring and locating device consisting of a transmitter worn by the child and a receiver in the possession of the parent. The parent's receiving unit is capable of detecting when the child strays beyond a pre-determined distance from the parent. This patent makes no reference to means for containing the child within a pre-determined area and/or means for communicating with the child or for locating the child if the child leaves a pre-determined area.

In view of the foregoing, it has become desirable to develop a system for containing a child within a defined area, communicating with that child when the child is within the defined area or outside the defined area, and for locating the child when the child has strayed from the defined area, using a wire loop located in the ground.

### SUMMARY OF THE INVENTION

The present invention solves the problems associated with the prior art systems for containing a child within a defined area, communicating with and/or locating a child, and other problems by providing a system that includes means for containing a child within a defined area, for communicating with the child and for locating the child if the child leaves the defined area. Utilizing a presently existing electronic pet containment system provides the containment capability of the system. Such a containment system utilizes a wire that is placed within the ground and on which a signal is applied thereto. The child wears a child monitoring module through which communication with a control unit can be maintained via radio frequency links. The control unit, which is typically in the possession of the child's parent, emits an audible alarm thus warning the parent that the child is approaching the wire. A similar audible alarm is also provided to the child by the monitoring unit. The parent can then use the transceiver associated with the control unit to communicate with the child and the child can communicate with the parent by using the transceiver in the child monitoring module. If the child crosses the wire defining the boundary of area, the audible alarm associated with the control unit changes pitch indicating to the parent that the child has crossed the established boundary. If the child crosses the established boundary and if the radio frequency capability of the control unit has been exceeded, the system includes an auxiliary power unit to increase the level of the radio frequency signal to and from the child monitoring module. The system also includes directional and distance locating capabilities to provide an indication to the parent as to the direction in which the child is moving and the distance between the child and the control unit.

### BRIEF DESCRIPTION OF THE DRAWINGS

FIG. 1 is schematic diagram of the child containment, communication and locating system of the present invention.

FIG. 2 is a schematic diagram of a child monitoring module utilized by the child containment, communication and locating system of the present invention.

FIG. 3 is a schematic diagram of the repeater utilized by the child containment, communication and locating system of the present invention.

FIG. 4 is a schematic diagram of the control unit utilized by the child containment, communication and locating system of the present invention.

FIG. 5 is a schematic diagram of the auxiliary power unit utilized by the child containment, communication and locating system of the present invention.

FIG. 6 is a schematic diagram of the battery charger utilized by the child containment, communication and locating system of the present invention.

### DESCRIPTION OF THE PREFERRED EMBODIMENT

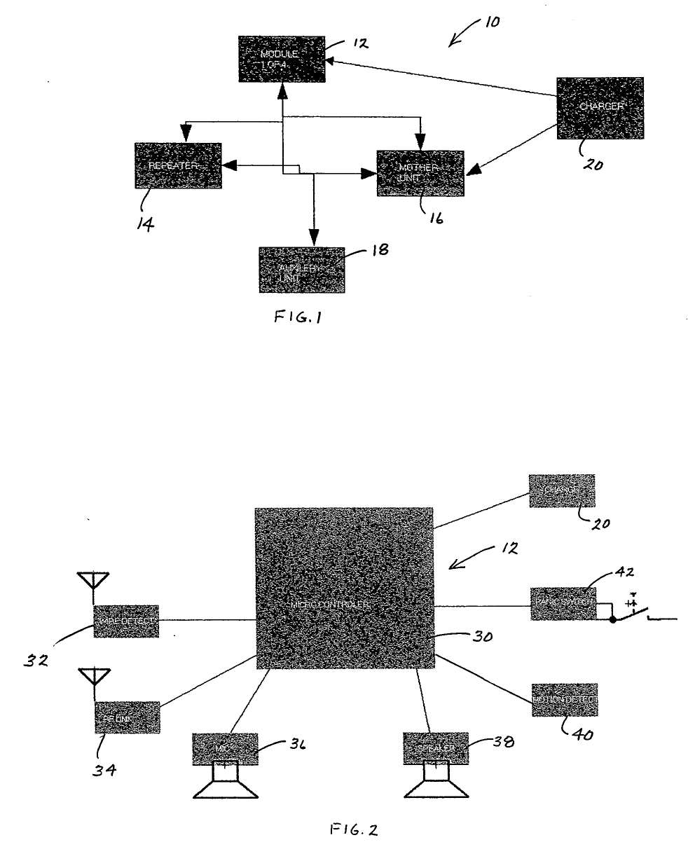

Referring now to the drawings where the illustrations are for the purpose of describing the preferred embodiment of the present invention and are not intended to limit the invention described herein, FIG. 1 is a schematic diagram of the child containment, communication and locating system 10 of the present invention. The system 10 is comprised of one or more child monitoring modules 12, a repeater 14, a control unit 16, an auxiliary power unit 18 and a battery charger 20. The child monitoring module 12 is worn by the child whose movements are being monitored within an area determined by the wire defining the periphery of a dog containment area. The module 12 transmits signals or selected data on a radio frequency band to the repeater 14, the control unit 16 and to the auxiliary power unit 18. The repeater 14 receives and retransmits signals or selected data from the child monitoring modules 12 to extend the range of the modules 12 and to fill gaps in the radio frequency reception area. The control unit 16 receives data from either the modules 12 or the repeater 14 and controls the operation of the system 10. The auxiliary power unit 18 receives signals or selected data from the repeater 14 and extends the detection range of the modules 12. The battery charger 20 provides controlled recharging of the batteries within the modules 12 and within the control unit 16.

Referring now to FIG. 2, a schematic diagram of a child monitoring module 12 is shown. The module 12 includes a microcontroller 30, a wire detector 32, a radio frequency link 34, a microphone audio input 36, a speaker audio output 38, a motion detector 40 and a panic switch 42. The wire detector 32 is connected to an input to the microcontroller 30 and detects existing signal from the wire defining the periphery of the dog containment area. The radio frequency link 34 is comprised of a transceiver that permits the module 12 to communicate with the control unit 16 using a radio frequency band. The microphone 36 provides an audio input to the microcontroller 30. The speaker 38 provides an audio output from the microcontroller 30. The motion detector 40 detects movement by the child and is connected to an input to the microcontroller 30. The panic switch 42 can be actuated by the child and is connected to an input to the microcontroller 30 and notifies the person monitoring the child, such as the child's mother, to communicate with the module 12 worn by the child. The battery charger 20 is connectable to an input to the microcontroller 30 to recharge the batteries within the module 12.

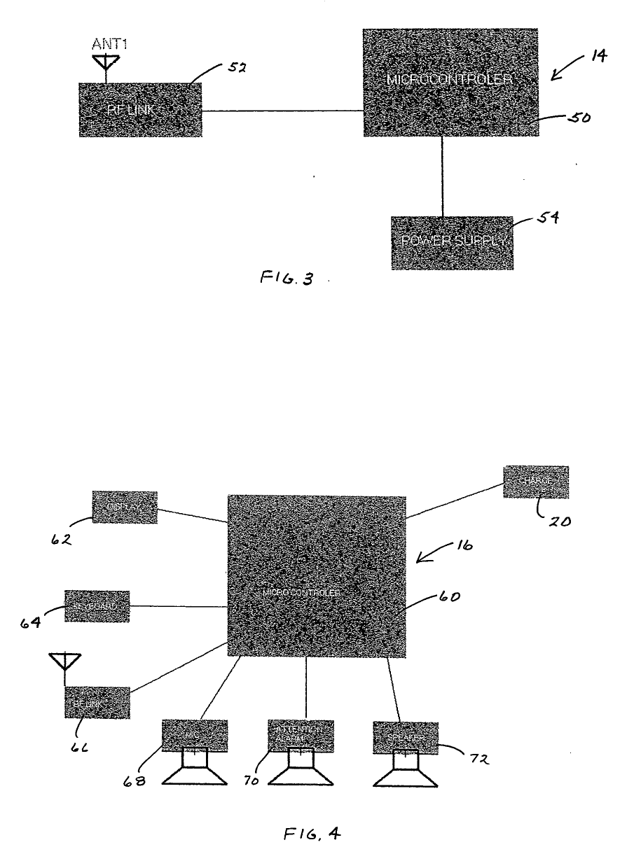

A schematic diagram of the repeater 14 is shown in FIG. 3. The repeater 14 is comprised of a microcontroller 50, a radio frequency link 52 and a power supply 54. The repeater 14 receives and retransmits signals or selected data from the modules 12, extending the range of the modules 12 and filling the gaps in the radio frequency reception area. The radio frequency link 52 comprises a transceiver that communicates with the child monitoring module 12 using the radio frequency band. The power supply 54 receives power from a 110 volt AC source and includes an adapter that converts the AC power to DC power to recharge the batteries within the repeater 14.

Referring now to FIG. 4, a schematic diagram of the control unit 16 is shown. The control unit 16 includes a microcontroller 60, a display 62, a keyboard 64, a radio frequency link 66, a microphone audio input 68, an attention alarm 70 and a speaker audio output 72. The display 62 is comprised of a two line, 16 character liquid crystal display and is used to display the operating functions of the system 10. The keyboard 64 is utilized to input data into the system 10 and to control the operation of same. The radio frequency link 66 is comprised of a transceiver that communicates with the child monitoring module 12 using the radio frequency band. The microphone 68 is connected to an input to the microcontroller 60. The attention alarm 70 and the speaker 72 are connected to outputs of the microcontroller 60. The battery charger 20 is connected to an input to the microcontroller 60 and is utilized to recharge the batteries within same.

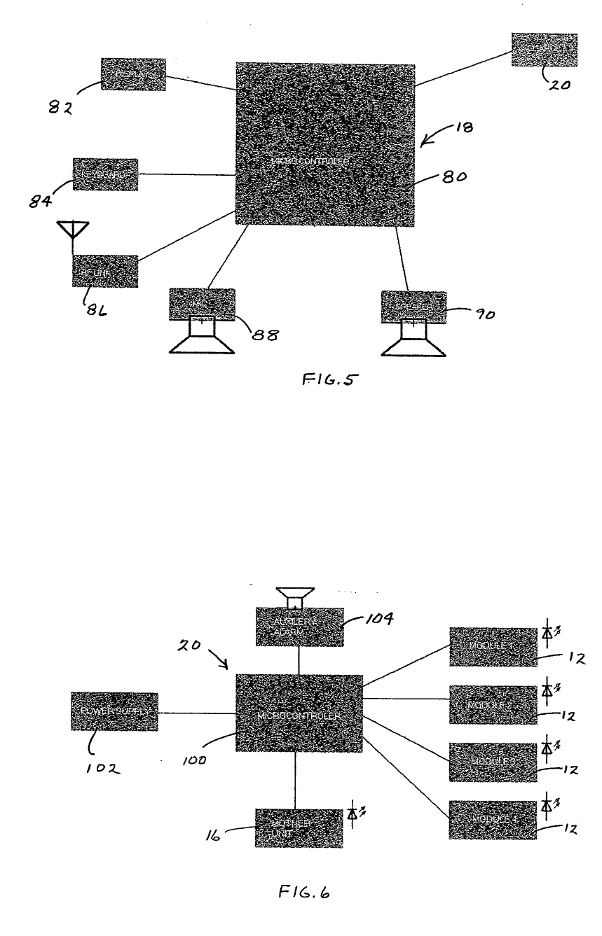

A schematic diagram of the auxiliary power unit 18 is shown in FIG. 5. The auxiliary power unit 18 is comprised of a microcontroller 80, a display 82, a keyboard 84, a radio frequency link 86, a microphone audio input 88 and a speaker audio output 90. The display 82 is comprised of a screen and is used to display the operating functions of the system 10 and the location of the child wearing the child monitoring module 12. The keyboard 84 is used to input data into the system 10 and to control the operation of same. The radio frequency link 86 is comprised of a transceiver which communicates with the child monitoring module 12 using the radio frequency band and which extends the range of the system 10 for several miles. The microphone 88 is connected to an input to the microcontroller 80. The speaker 90 is connected to an output of the microcontroller 80. The battery charger 20 is connectable to an input to the microcontroller 80 and is used to recharge the batteries within same.

Referring now to FIG. 6, a schematic diagram of the battery charger 20 is illustrated. The battery charger 20 is comprised of a microcontroller 100, a power supply 102 and an auxiliary alarm 104. The power supply 102 provides power to the microcontroller 100. The auxiliary alarm 104 provides an additional alarm for the system 10. Charging jacks are provided on the charger 20 permitting the recharging of up to four (4) child monitoring modules 12 and the control unit 16. Light emitting diodes (not shown) are provided on the charger 20 to indicate the charging status of each module 12 that is connected to the charger 20.

The control unit 16 is typically located within a residence that has a pet containment system associated therewith. The pet containment system includes a generator that produces the signals that are applied to the wire that defines the periphery of the pet containment area. As previously indicated, the child monitoring module 12 is worn by the child whose movements are being monitored within the area determined by the wire defining the periphery of the pet containment area.

To operate the system 10 of the present invention, the control unit 16 and one or more child monitoring modules 12 are initially charged by the charger 20. After charging has been completed, using the keyboard 64 associated with the control unit 16, the control unit 16 is programmed to insure the accessibility of each of the child monitoring modules 12. The input data that is programmed into the control unit 16 may include the name, address, and telephone number of the child who will wear the child monitoring module 12 and a unique digital identifier code for the module 12. Assuming that two (2) child monitoring modules 12 are involved for discussion purposes, the control unit 16 would be programmed for each of the two modules 12 and programs same. After programming has been completed, the first child monitoring module 12 is attached to the first child and the second child monitoring module 12 is attached to the second child whose movements are being monitored within an area determined by the wire defining the periphery of a dog containment area. If the mother of the children wearing the modules 16 would like to talk to the first child, the mother presses the voice command button associated with the control unit 16 and speaks to the first child via the microphone 68 in the control unit 16. The transceiver comprising the radio frequency link 66 in the control unit 16 transmits the mother's message to the first child via the radio frequency link 34 and the speaker 38 in the first child's module 12. When the mother has completed her message to the first child, the first child can respond to the mother via the microphone 36 in its module 12. The transceiver comprising the radio frequency link 34 in the module 12 transmits the first child's message to the mother via the radio frequency link 66 and the speaker 72 associated with the control unit 16. If the mother would like to listen to either of the children, the mother accesses the child monitoring module 16 worn by that child and presses the voice command button on the control unit 16. As long as the voice command button is depressed, the child's voice will be transmitted via the microphone 36 in its module 12. Here again, the transceiver comprising the radio frequency link 34 in the child's module 12 transmits the child's voice to the mother via the radio frequency link 66 and the speaker 72 associated with the control unit 16.

If one of the children decides to remove its child monitoring module 12, the motion detector 40 associated with the module 12 detects that no motion is occurring to the module 12 and causes the transceiver comprising the radio frequency link 34 in the module 12 to transmit a signal via radio frequency link 66 to control unit 16 activating the attention alarm 70 in the control unit 16. The mother in this instance can investigate why the child has removed its module 12 and take appropriate corrective action. After taking such action, the mother then resets attention alarm 70 associated with control unit 16. If one of the children seeks the mother's attention, the child pushes the panic switch 42 associated with its module 12 causing the transceiver comprising the radio frequency link 34 in the module 12 to transmit a signal via radio frequency link 66 to the control unit 16 causing the attention alarm 70 in the control unit 16 to again be activated. In this case, the mother would take the appropriate action and then reset the attention alarm 70 associated with control unit 16.

If the child decides to leave the area typically defined by the wire associated with the pet containment system, the wire detector 32 associated with its module 12 detects that the child is approaching the wire and causes the transceiver comprising the radio frequency link 34 in the module 12 to transmit a signal via radio frequency link 66 to control unit 16 activating attention alarm 70 in the control unit 16. In this instance, the mother can then investigate the location of the child and take appropriate action. After the mother has taken appropriate action, the mother then resets the attention alarm 70 associated with the control unit 16. If the child crosses the wire defining the confined area before the mother takes appropriate action, the attention alarm 70 associated with the control unit 16 changes pitch indicating to the mother that the child has crossed the established boundary. The mother, in this instance, can then press the voice command button associated with the control unit 16 and speak to the child via the microphone 68 in the control unit 16. The transceiver comprising the radio frequency link 66 in the control unit 16 transmits the mother's message to the child via radio frequency link 34 and the speaker 38 in the module 12 worn by the child. If the child ignores the voice messages of the mother, the mother can activate the directional and distance location capabilities of the control unit 16. Using the directional and location capabilities of the control unit 16, the mother can then locate the child.

If the child has crossed the wire defining the confined area and if the radio frequency capability of the control unit 16 has been exceeded, i.e., communication has been lost between the control unit 16 and the child monitoring module 12, the transceiver comprising the radio frequency link 66 in the control unit 16 causes the activation of auxiliary power unit 18 via radio frequency link 86 associated with auxiliary power unit 18. The auxiliary power unit 18 increases the level of the radio frequency signal to and from the child monitoring module 12. The mother can then call the police for assistance. Through directional and distance locating methods, the police will then attempt to locate the child using the signal transmitted by the auxiliary power unit 18 and received from the child monitoring unit 12.

If the police cannot locate the child through directional and distance locating methods, System Omni can be activated to scan a larger geographical area. System Omni can determine the location of an individual by coordinates and such information is then transmitted to the police who can determine the individual's location. If the police cannot locate the child, all System Omni units in the surrounding areas can be utilized to locate the child. In this instance, any control unit 16 within the radio frequency range of the child monitoring module 12 can intercept the signal from the module 12, along with the child's telephone number and the unique digital identifier code that has been assigned to the child, permitting communication to the police of the child's approximate location. In this manner, the child can be located.

It should be noted that if the battery power level within the child monitoring module 12 drops to a predetermined level, the control unit 16 is notified of same by the transceiver comprising the radio frequency link 34 in the module 12 and the radio frequency link 66 in the control unit 16. In this situation, voice communication between the module 12 and the control unit 16 ceases. If the power level of the module 12 drops further, the transceiver comprising the radio frequency link 34 in the module 12 produces a signal which is transmitted via the radio frequency link 34 to the control unit 16 via radio frequency link 66 causing the control unit 16 to sound an alarm. In this instance, the control unit 16 cannot be reset until the child monitoring module 12 has been recharged.

Certain modifications and improvements will occur to those skilled in the art upon reading the foregoing. It is understood that all such modifications and improvements have not been included herein for the sake of conciseness and readability, but are properly within the scope of the following claims.

1) A child containment, communication and locating system utilizing the wire defining the periphery of a pet containment area comprising at least one child monitoring module worn by the child whose movement is to be monitored, said at least one child monitoring module including means for receiving the signal applied to the wire defining the periphery of the pet containment area and including a transceiver device, and a unit to control the operation of the system, said control unit including a transceiver device;

2) The system as defined in claim 1 wherein said transceiver device in said at least one child monitoring module has the capability of communicating with said transceiver device in said control unit and said transceiver device in said control unit has the capability of communicating with said transceiver device in said at least one child monitoring module.

3) The system as defined in claim 2 wherein said transceiver device in said at least one child monitoring module communicates with said transceiver device within said control unit via a radio frequency band and said transceiver device in said control unit communicates with said transceiver device in said at least one child monitoring module via said radio frequency band.

4) The system as defined in claim 1 wherein said at least one child monitoring module includes means for detecting a signal on the wire defining the periphery of the pet containment area.

5) The system as defined in claim 4 wherein the detection of a signal on the wire defining the periphery of the pet containment area by said detecting means causes said at least one child monitoring module to communicate with said control unit via said transceiver device in said at least one child monitoring module and said transceiver device in said control unit.

6) The system as defined in claim 1 further including at least one repeater device which receives and retransmits signals from said at least one child monitoring module to extend the transmission and reception range of said at least one child monitoring module.

7) The system as defined in claim 1 further including an auxiliary power unit to increase the level of said signals to and from said at least one child monitoring module.

8) The system as defined in claim 1 further including means to determine the direction of travel of the child wearing said at least one child monitoring module after the child has crossed the wire defining the periphery of the pet containment area.

9) The system as defined in claim 1 further including means for determining the distance of the child from said control unit after the child wearing said at least one child monitoring module has crossed the wire defining the periphery of the pet containment area.

10) The system as defined in claim 1 wherein said at least one child monitoring module includes means for detecting when said at least one child monitoring module is stationary indicating that said at least one child monitoring module has been removed by the child whose movements are being monitored.

11) The system as defined in claim 1 wherein said at least one child monitoring module includes means for transmitting a message from the child to said control unit.

12) The system as defined in claim 1 wherein said at least one child monitoring module includes means for receiving a message from said control unit.

13) The system as defined in claim 1 wherein said control unit includes means for transmitting a message to said at least one child monitoring module.

14) The system as defined in claim 1 wherein said control unit includes means for receiving a message from said at least one child monitoring module.

15) The system as defined in claim 5 wherein said auxiliary power unit includes means for transmitting a message to said at least one child monitoring module.

16) The system as defined in claim 5 wherein said auxiliary power unit includes means for receiving a message from said at least one child monitoring module.
